(19) United States
(12) Patent Application Publication
(10) Pub. No.: US 2004/0093393 A1
(43) Pub. Date: May 13, 2004

(54) System and method for selecting a media file for a mobile device

(75) Inventors: Michael P. Calligaro, Redmond, WA (US); Chee H. Chew, Redmond, WA (US); Kevin T. Shields, Bellevue, WA (US); Joe Belfiore, Seattle, WA (US)

Correspondence Address: MERCHANT & GOULD, P.O. BOX 2903, MINNEAPOLIS, MN, 55402-0903, US

(73) Assignee: Microsoft Corporation, Redmond, WA (US)

(21) Appl. No.: 10/289,753

(22) Filed: Nov. 7, 2002

(51) Int. Cl. G06F 15/16

(52) U.S. Cl. 709/219

(57) ABSTRACT

A system and method is directed to selecting a media file for a mobile device. The system is configured to select a media file from a plurality of media files based in part on a selection rule, and a heuristic associated with the media file. Heuristics are collected based in part on execution of the media file. The heuristics may include skipping a media file, repeating a-media file, and a frequency of execution of the media file. In one embodiment, a user interface enables a consumer to determine a frequency the media file is selected. The selection rule may include selecting a media file based on an artist, a seasonal characteristic of the media file, size of the media file, frequency of selection of the media file, and other heuristics associated with the media file.

### FIELD OF THE INVENTION

The present invention relates generally to computer-executable software, and more particularly to a system and method for intelligently selecting a media file for a mobile device.

### BACKGROUND OF THE INVENTION

There is an increased desire by consumers to copy music from their Compact Discs (CDs) onto their personal computers. This enables them to transfer the copied music onto portable music players, smart phones, and other portable devices. As consumers continue to copy their music onto their personal computers, the volume of stored music files on their personal computers increases, often into the gigabytes of required storage space.

It is also common for consumers to download digital photographs onto their personal computers. Such digital photographs may include family pictures, vacation pictures, and the like. Moreover, consumers may download for their enjoyment other media files onto their personal computers, such as screen shots, wallpapers, movies, audio files, and other media files.

As the volume of media files increases on the consumer's personal computer, the difficulty of managing and selecting which media files to download onto a portable device increases. Today, a consumer may spend considerable time sorting through virtually gigabytes of music files, pictures, movies, and the like to determine which media file to download onto their portable device. If the consumer desires to download the selected media files to multiple portable devices, more time may be consumed. Moreover, if the consumer desires to maximize their enjoyment of the portable device, by occasionally varying the media files selected for download, even more time may be consumed.

The process of selecting and downloading media files often becomes overwhelming when one realizes that the current portable devices include storage space constraints that limit how many, and sometimes even which media file may be downloaded. Because of the time that may be consumed in selecting and downloading media files to their portable devices, many consumers quickly become frustrated, and dissatisfied with the process. Therefore, there is a need in the art for a system and method for providing a media file to a mobile device. It is with respect to these considerations and others that the present invention has been made.

### SUMMARY OF THE INVENTION

This summary of the invention section is intended to introduce the reader to aspects of the invention and is not a complete description of the invention. Particular aspects of the invention are pointed out in other sections herein below, and the invention is set forth in the appended claims, which alone demarcate its scope.

The present invention provides a system and method for selecting a media file for inclusion on a mobile device. In one aspect of the present invention, a system is directed to selecting a media file. The system includes a media store, a monitor, and a media manager. The media store is configured to store a plurality of media files. The monitor is configured to determine a heuristic associated with each media file in the plurality of media files. Moreover, the media manager, which is coupled to the media store and the monitor, is configured to select the media file from the plurality of media files based in part on the heuristic associated with the media file and a selection rule.

In another aspect of the present invention, an apparatus is directed to selecting a media file for a mobile device. The apparatus includes a media store, a heuristics manager, a user interface, and a media manager. The media store is configured to store a plurality of media files. The heuristic manager is configured to determine a heuristic associated with each media file in the plurality of media files. The user interface is configured to provide a user criterion, such that the user criterion enables identification of a selection rule. The media manager is coupled to the media store. Moreover, the heuristic manager is configured to select the media file from the media store based in part on the heuristic associated with each media file, and the selection rule.

In yet another aspect of the present invention, an apparatus is directed to selecting a media file. The apparatus includes a monitor, and a media manager. The monitor is configured to determine a heuristic associated with the media file. The media manager is coupled to the monitor, and is configured to receive the media file. The media file is selected based in part on the heuristic associated with the media file, and a selection rule.

In still another aspect of the present invention, a computer-implemented method is directed to selecting a media file. The computer-implemented method receives the media file, determines a heuristic associated with the media file, and if the heuristic associated with the media file satisfies a selection rule, selects the media file for downloading to a mobile device.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates a block diagram generally showing an overview of one embodiment for a selection system in which the present invention may operate;

FIG. 2 illustrates a functional block diagram of one embodiment of a media selector shown in FIG. 1 employing components for selecting a media file;

FIG. 3 shows an exemplary desktop device for practicing the present invention as shown in FIG. 1; and

FIG. 4 is a flow diagram generally showing one embodiment of a process of selecting a media file, in accordance with the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Briefly stated, the present invention is directed to a system and method for selecting a media file. In one embodiment, the media file is selected for download to a mobile device. Media files may be selected by employing a heuristic associated with the media file and at least one selection rule. Several heuristics may be associated with the media file. Heuristics may be gathered during the execution of the media file. Selection rules may be pre-defined. Selection rules may also be added, modified, or deleted by the user. Moreover, a service, such as a service provider, and the like, may direct recommendations for purchases, downloads, and the like, of another media file to the user, based in part on the gathered heuristics.

Illustrative Environment

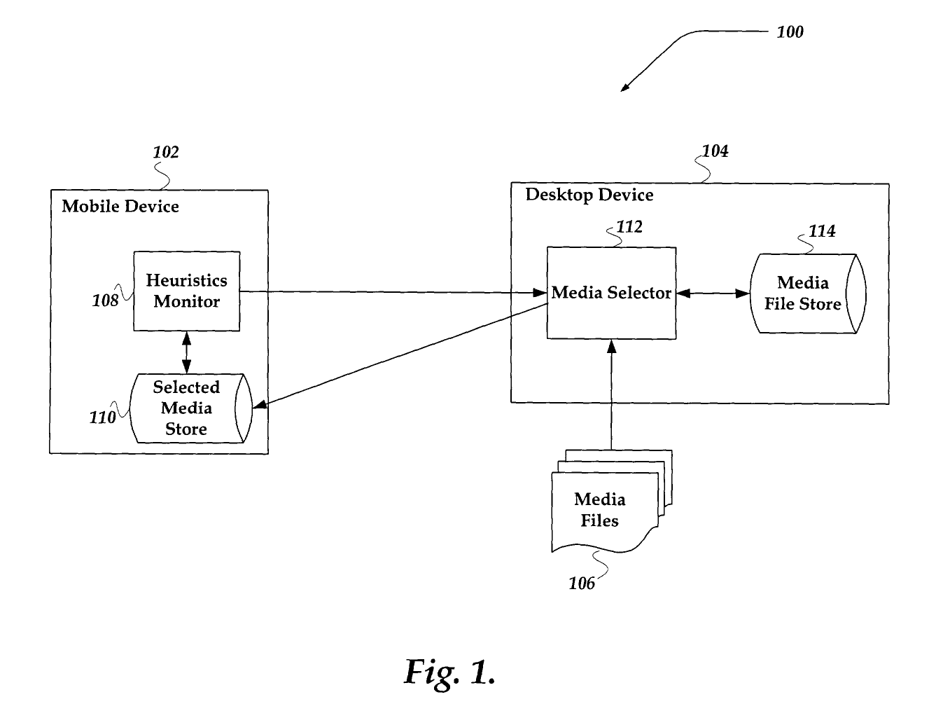

FIG. 1 illustrates a block diagram generally showing an overview of one embodiment for a selection system in which the present invention may operate. As shown in the figure, selection system 100 includes mobile device 102, desktop device 104, and media files 106. Mobile device 102 includes heuristics monitor 108, and selected media store 110. Desktop device 104 includes media selector 112, and media file store 114. Selection system 100 may include many more components than those shown in FIG. 1. For example, in another embodiment, media selector 112 is also included in mobile device 102. The components shown, however, are sufficient to disclose an illustrative embodiment for practicing the invention.

Heuristics monitor 108 is in communication with selected media store 110, and media selector 112. Media selector 112 is also in communication with media file store 114, media files 106, and selected media store 110.

Generally, mobile device 102 may include any portable device capable of connecting to another computing device and receiving a media file. Such devices include cellular telephones, smart phones, display pagers, radio frequency (RF) devices, infrared (IR) devices, integrated devices combining one or more of the preceding devices, and the like. Mobile device 102 may also include other devices, such as Personal Digital Assistants (PDAs), handheld computers, tablet computers, personal computers, multiprocessor systems, microprocessor-based or programmable consumer electronics, network PCs, wearable computers, electronic picture frames, and the like. As such, mobile devices typically range widely in terms of capabilities and features. For example, a cellular telephone may have a numeric keypad and a few lines of monochrome Liquid Crystal Display (LCD) on which a media file may be displayed. A PDA may have a touch sensitive screen, a stylus, and several lines of color display in which text, graphics, and movie media file types may be displayed.

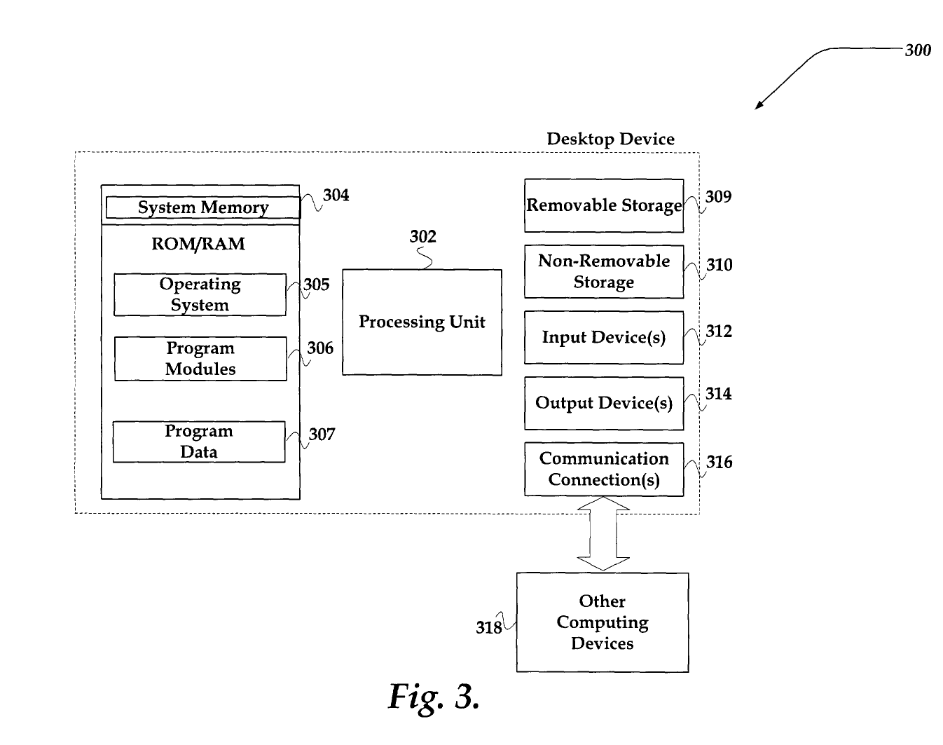

Desktop device 104 is described in more detail below in conjunction with FIG. 3. Briefly, however, desktop device 104 may include any computing device capable of connecting to mobile device 102, to make a media file available to mobile device 102. Such devices include personal computers, multiprocessor systems, microprocessor-based or programmable consumer electronics, network PCs, servers, and the like. Moreover, desktop device 104 is also configured to make media files 106 available to media selector 112 from a variety of sources, including a network, floppy disc, portable memory chip, Compact Disc (CD), Digital VideoDisc (DVD), and the like.

Media files 106 includes any of a variety of digital file types including, but not limited to, audio, video, movies, still images, text, graphics, and other forms of digital content, independent of the data format. For example, media files 106 may include music files, digital movies, and digital photographs.

Media file store 114 is configured to provide storage for a media file. Media file store 114 may include a database, a flat file, a directory structure, and the like. The media file may be stored in a directory structure based on the media file type. For example, digital photographs may be stored in a separate directory than audio media files. An audio file may be stored based on an artist associated with the audio file, a seasonal characteristic, and the like.

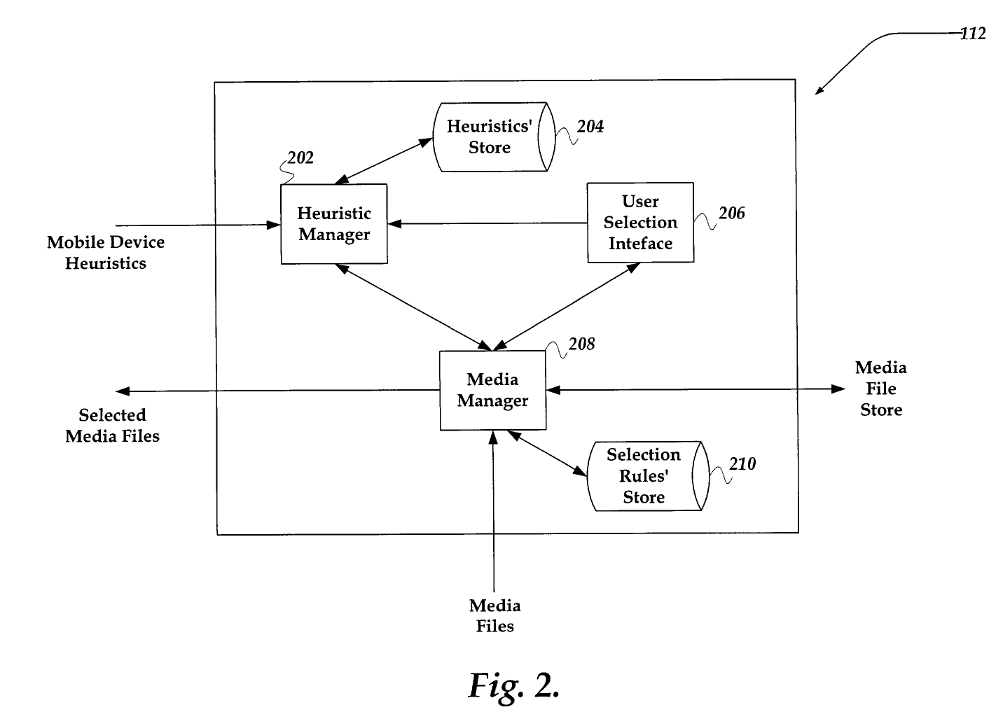

Media selector 112 is described in more detail below in conjunction with FIG. 2. Briefly, however, media selector 112 is configured to select a media file from media file store 114 based in part on a selection rule and a heuristic associated with the media file. Media selector 112 is further configured to make the selected media file available to selected media store 110 and to receive the heuristic associated with the media file from heuristics monitor 108 on mobile device 102.

In one embodiment, media selector 112 may enable a media file to be reformatted in response to a capability of mobile device 102. For example, if the resolution capability of mobile device 102 is about 320×240, with approximately 256 colors, then media selector 112 may enable a 1028×764 media file, with 65M colors to be reformatted for the capability of mobile device 102. Media selector 112 may employ any of a variety of mechanisms known in the art to reformat the media file.

Heuristics monitor 108 is configured to determine a heuristic associated with the media file. Heuristics monitor 108 is further configured to provide the heuristic to media selector 112. The heuristic provides a mechanism for describing information about the media file. The heuristic may include information gathered during the execution of the media file, including a frequency of execution of the media file, whether the user has skipped the media file, whether the user has repeated the media file, and the like. As such, the heuristic typically includes dynamic information associated with the media file.

Heuristics monitor 108 may also include a user selection interface (not shown) that is configured to receive a user criterion that enables identification of a heuristic associated with the media file.

Selected media store 110 is configured to provide storage for the selected media file received from media selector 112. Selected media store 110 is also configured to provide the selected media file to heuristics monitor 108. Selected media store 110 may include a database, a flat file, a directory structure, and the like.

FIG. 2 illustrates a functional block diagram of one embodiment of media selector 112 in FIG. 1, employing components for selecting a media file. Media selector 112 may include many more components than those shown. However, the components shown are sufficient to disclose an illustrative embodiment for practicing the invention.

Media selector 112 includes heuristic manager 202, heuristics' store 204, user selection interface 206, media manager 208, and selection rules' store 210.

Heuristics manager 202 is in communication with heuristics' store 204, and user selection interface 206. Heuristics manager 202 is also in communication with media manager 208. User selection interface 206 is in communication with media manager 208. Additionally, media manager 208 is also in communication with selection rules' store 210.

Heuristics' store 204 is configured to provide storage for the heuristic associated with the media file. Heuristics' store 204 may include a database, a flat file, a directory structure, and the like.

Heuristics manager 202 is configured to receive heuristics associated with a media file from a mobile device, and the like. Heuristics manager 202 is further configured to receive heuristics associated with a media file from user interface 206, integrate the heuristics received from the mobile device, and provide the integrated heuristics to heuristics' store 204. Heuristics manager 202 is also configured to provide heuristics associated with the media file to media manager 208 upon request.

Selection rules' store 210 is configured to provide storage for a selection rule. Selection rules' store 210 may include a database, a flat file, a directory structure, and the like. A selection rule includes instructions, tests, comparisons, and the like that enable a determination of which media file is selected. For example, selection rules may include selecting the media file based in part on space available on a mobile device, selecting a newer media file over an older media file, selecting the media file based on an artist, selecting the media file based on a season, and selecting the media file based on a media type, wherein the media type is at least one of an audio, video, graphic, and text type, and size. Selection rules may further include selecting the media file based on a frequency of selection; if the media file includes a sequence of media files, selecting the media file based on where in the sequence the media file is located; selecting the media file based on a pre-determined category of media files; selecting the media file based on a time the media file was last selected; selecting based on a user criteria; selecting the media file based other heuristics; and the like. Selection rules may also include information provided through user selection interface 206. For example, a selection rule may be based in part on a user's preference, such as selecting only a user's favorite media files, never selecting a media file, and the like. Moreover, selection rules may include virtually any condition, test, and the like that distinguishes one media file from another media file.

User selection interface 206 is configured to receive a user criterion that enables identification of the selection rule. The user criterion may also enable identification of a heuristic associated with the media file. User criterion provides a mechanism for describing information about at least one of a media file, and a selection rule. The information about the media file may include, but is not limited to, rating of a like, dislike, scaled rating, and the like. For example, user criterion may indicate a media file that the user prefers not to ever have selected. User criterion may also include information such as an artist associated with the media file, a season associated with the media file, a frequency of selection of the media file, and the like. For example, the user criterion may enable a media file to always be selected, never selected, or selected at some frequency. Information about the selection rule may include deleting the selection rule, adding the selection rule, and modifying the selection rule.

In one embodiment, the user is prompted for a user criterion as the media file is downloaded to desktop device 104. For example, the user criterion may identify the media file to be selected the next time files are downloaded to mobile device 102. The user criterion may also indicate that the media file is never selected for download, selected based on a frequency of selections, and the like. Entry of the user criterion also is not limited to when the media file is downloaded. It may be provided by the user, through user selection interface 206 at another time, without departing from the scope or spirit of the present invention.

User selection interface 206 is further configured to forward user criteria that enable the selection rule to media manager 208. Additionally, user selection interface 206 is configured to forward user criteria that enable the heuristic associated with the media file to heuristic manager 202.

Media manager 208 is configured to receive the user criterion associated with the selection rule from user interface 206. Media manager 208 employs the user criterion associated with the selection rule to manage the selection rule in selection rules' store 210.

Media manager 208 is also configured to manage the selection of a media file, based in part on at least one heuristic associated with the media file, and at least one selection rule. Media manager 208 is configured to receive a media file from media file store 114 in FIG. 1. Media manager 208 is enabled to employ the selection rule from selection rules' store 210, and a heuristic associated with the media file to determine whether to select the media file. In one embodiment, media manager 208 is enabled to make the selected media file available to a mobile device.

In another embodiment, media manager 208 is directed to provide heuristics to a service, such as a service provider, media owner, media distributor, and the like, to enable the service to recommend another media file to the user, based in part on the provided heuristics.

FIG. 3 shows an exemplary desktop device for practicing the present invention, according to one embodiment of the invention. As seen in FIG. 3, the system includes desktop device 300. In a very basic configuration, desktop device 300 typically includes at least one processing unit 302 and system memory 304. Processing unit 302 includes existing physical processors, those in design, multiple processors acting together, virtual processors, and any other device or software program capable of interpreting binary executable instructions. Depending on the exact configuration and type of computing device, system memory 304 may be volatile (such as RAM), non-volatile (such as ROM, flash memory, etc.), or some combination of the two. System memory 304 may include an operating system 305, one or more program modules 306, and program data 307. Examples of program modules include email programs, scheduling programs, user interface programs, media selector, spreadsheet programs, and the like. Program modules 306 may use program data 307 to manage information, such as user criteria, heuristics associated with a media file, selection rules, and the like. Moreover, program modules 306 may also include a synchronization program that is programmed to interact with a corresponding synchronization application resident on a mobile device, such as mobile device 102 shown in FIG. 1, to keep information synchronized with corresponding information stored on the mobile device.

Desktop device 300 may also have additional features or functionality. For example, desktop device 300 may also include additional data storage devices (removable and/or non-removable) such as, for example, magnetic disks, optical disks, or tape. Such additional storage is illustrated in FIG. 3 by removable storage 309 and non-removable storage 310. Computer storage media may include volatile and non-volatile, removable and non-removable media implemented in any method or technology for storage of information, such as computer readable instructions, data structures, program modules, or other data. System memory 304, removable storage 309, and non-removable storage 310 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the media files, and the like, which can be accessed by desktop device 300. Any such computer storage media may be part of desktop device 300. Computing device 100 may also have input device(s) 312 such as keyboard, mouse, pen, voice input device, touch input device, etc. Output device(s) 314 such as a display, speakers, printer, and the like, may also be included. All these devices are known in the art and need not be discussed at length here.

Desktop device 300 may also contain communications connection(s) 316 that allows the device to communicate with other computing devices 318, such as over a network, where a media file, and the like may be downloaded. Communications connection(s) 316 is an example of communication media. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Generalized Operation

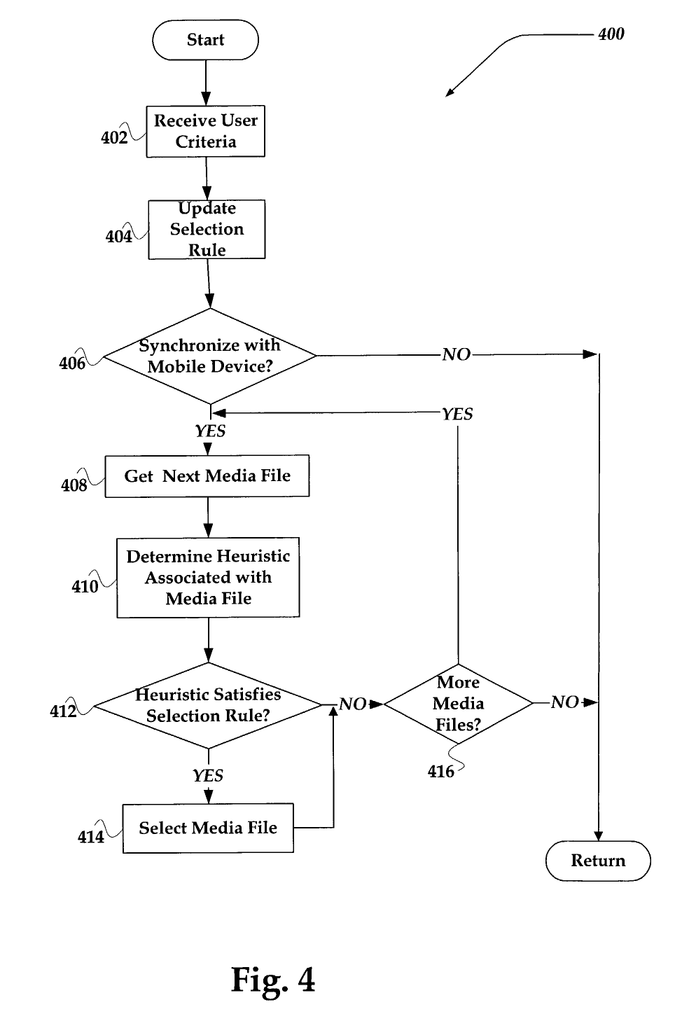

The operation of certain aspects of the present invention will now be described with respect to FIG. 4. FIG. 4 is a flow diagram generally showing an embodiment of a process of selecting a media file, in accordance with the present invention.

Process 400 begins, after a start block, at block 402 where user criteria is received. User criteria may include a selection rule to be added, modified, or deleted. User criteria may include a selection rule that modifies the frequency of selection of a media file such that the media file may be always selected, never selected, sometimes selected, and the like. In one embodiment, user criteria may include a rating associated with a media file, such as a like, dislike, or scaled voting of a media file. User criteria may also include information about the media file including if the media file is associated with a season, artist, subject matter, family member, friend, event, and the like. User criteria need not be entered however. For example, in one embodiment, the invention includes pre-determined selection rules that may be employed to select the media file. Process flow then proceeds to block 404, where the user criteria are employed to modify the selection rule. In one embodiment, the user criteria are employed to modify a heuristic associated with the media file.

Process 400 continues to decision block 406, where a determination is made whether to synchronize with a mobile device. At decision block 406, if it is determined not to synchronize with the mobile device, the process returns to performing other actions.

Alternatively, at decision block 406, if it is determined to synchronize with the mobile device, the process proceeds to block 408, where the media file is obtained. The process flows next to block 410, where a heuristic associated with the obtained media file is determined. It is noted that the obtained media file may have more than one heuristic associated with it.

The process continues to decision block 412, where a determination is made whether the heuristic associated with the media file satisfies the selection rule identified at block 402. Several selection rules may be evaluated against the heuristic to determine if at least one selection rule is satisfied.

If it is determined that no heuristic satisfies at least one selection rule, the process flows to decision block 416. Alternatively, if it is determined that the heuristic satisfies at least one selection rule, the process flows to block 414, where the media file associated with the heuristic is selected. In one embodiment, the selected media file is made available to a mobile device. Process 400 then flows to decision block decision block 416.

At decision block 416, a determination is made whether there are any more media files to be examined. If at decision block 416, it is determined that more media files are to be examined, the process returns to block 408, where substantially similar actions as described above are performed. Alternatively, if, at decision block 416, it is determined that no more media files are to be examined, process 400 returns to performing other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A system for selecting a media file, comprising:
a media store configured to store a plurality of media files;
a monitor configured to determine a heuristic associated with each media file in the plurality of media files; and
a media manager coupled to the media store and the monitor, and configured to select the media file from the plurality of media files based in part on the heuristic associated with the media file and a selection rule.

2. The system of claim 1, further comprising:
a user interface configured to provide a user criterion, wherein the user criterion identifies the selection rule.

3. The system of claim 2, wherein the user criterion further comprises means for describing information about each media file, wherein the information enables selection of the media file.

4. The system of claim 1, further comprising a mobile device including a second media store.

5. The system of claim 1, further comprising a mobile device including a user interface configured to identify the heuristic associated with the selected media file.

6. The system of claim 1, wherein the media manager is further configured to make the selected media file available to a mobile device.

7. The system of claim 1, wherein the selection rule further comprises means for determining which media file in the plurality of media files is selected.

8. The system of claim 1, wherein the heuristic associated with the media file further comprises means for describing information about the media file, wherein the information enables the selection of the media file from the plurality of media files.

9. An apparatus for selecting a media file for a mobile device, comprising:
a media store configured to store a plurality of media files;
a heuristic manager configured to determine a heuristic associated with each media file in the plurality of media files;
a user interface configured to provide a user criteria, wherein the user criteria enables identification of a selection rule; and
a media manager coupled to the media store, and the heuristic manager, and configured to select the media file from the media store based in part on the heuristic associated with each media file, and the selection rule.

10. The apparatus of claim 9, wherein the media store further comprises at least one of a database, a flat file, and a directory.

11. The apparatus of claim 9, wherein the user criteria further comprises means for describing information about each media file, wherein the information enables selection of the media file.

12. The apparatus of claim 9, wherein the user criteria further comprises at least one of a frequency of selection and a user rating of the media file.

13. The apparatus of claim 12, wherein the user rating further comprises at least one of a like rating, dislike rating, and a scaled rating.

14. The apparatus of claim 9, wherein the user interface is further configured to determine the user criteria when the media file is provided to the media store.

15. The apparatus of claim 9, wherein the user interface is further configured to determine the user criteria as the media file is executed.

16. The apparatus of claim 9, wherein the selection rule further comprises means for determining which media file in the plurality of media files is selected.

17. The apparatus of claim 9, wherein the user interface is further configured to create the selection rule.

18. The apparatus of claim 9, wherein the heuristic associated with the media file further comprises means for describing information about the media file, wherein the information enables the selection of the media file from the plurality of media files.

19. The apparatus of claim 9, wherein media manager is further configured to enable the media file to be reformatted based in part on a capability of the mobile device.

20. The apparatus of claim 9, wherein the media manager is further configured to reformat the media file based in part on a capability of the mobile device.

21. An apparatus for selecting a media file, comprising:
a monitor configured to determine a heuristic associated with the media file; and
a media manager coupled to the monitor, and configured to receive the media file, wherein the media file is provided based in part on the heuristic associated with the media file, and a selection rule.

22. The apparatus of claim 21, wherein the media manager is further configured to provide the heuristic associated with the media file to another apparatus.

23. The apparatus of claim 21, further comprising a user interface means for describing information about each media file, wherein the information enables selection of the media file.

24. The apparatus of claim 21, further comprising a media store for storing the received media file.

25. The apparatus of claim 21, wherein the selection rule further comprises means for determining which media file in the plurality of media files is selected.

26. The apparatus of claim 21, wherein the heuristic associated with the media file further comprises means for describing information about the media file, wherein the information enables the selection of the media file from the plurality of media files.

27. A computer-implemented method for selecting a media file, comprising:
receiving the media file;
determining a heuristic associated with the media file; and
if the heuristic associated with the media file satisfies a selection rule, selecting the media file for downloading to a mobile device.

28. The computer-implemented method of claim 27, further comprising:
receiving a user criteria; and
modifying at least one of the heuristic associated with the media file, and the selection rule based at least in part on the user criteria.

29. The computer-implemented method of claim 27, wherein the user criteria further comprises means for describing information about the media file, wherein the information enables selection of the media file.

30. The computer-implemented method of claim 29, wherein modifying further comprises adding at least one of the heuristic associated with the media file and the selection rule.

31. The computer-implemented method of claim 27, wherein the selection rule further comprises means for determining which media file is selected.

32. The computer-implemented method of claim 27, wherein the heuristic associated with the media file further comprises means for describing information about the media file, wherein the information enables the selection of the media file.

33. The computer-implemented method of claim 27, wherein selecting the media file further comprises reformatting the media file based in part on a capability of the mobile device.

34. The computer-implemented method of claim 27, further comprising providing the heuristic to a service, wherein the heuristic enables the service to recommend another media file.
